(19) United States
(12) Patent Application Publication
(10) Pub. No.: US 2014/0209334 A1
(43) Pub. Date: Jul. 31, 2014

(54) VERTICUTTING DEVICE AND BLADE BODY FOR USE IN SUCH A DEVICE

(71) Applicant: Jo Beau Products BVBA, Brugge (BE)

(72) Inventor: Jozef Beauprez, Sint-Andries (BE)

(73) Assignee: Jo Beau Products BVBA, Brugge (BE)

(21) Appl. No.: 14/165,678

(22) Filed: Jan. 28, 2014

(30) Foreign Application Priority Data
Jan. 28, 2013 (BE) 2013/0053

(51) Int. Cl. A01B 45/02

(52) U.S. Cl. CPC A01B 45/026
USPC 172/21

(57) ABSTRACT

Device for aerating a lawn, comprising a frame in which a shaft is rotatably mounted, characterized in that the shaft is provided with a plurality of mounting arms, wherein each mounting arm is provided with at least one removably mounted blade body, which blade body is provided on the mounting arm at a location such that disruptive elements in the lawn, such as moss and dead grass, are dislodged by the blade body during the rotation of the shaft.

### TECHNICAL FIELD

The present invention relates to a device for aerating a lawn, also referred to as a lawn aerator or a verticutter. In addition, the invention relates to a blade body for use in such a device.

### BACKGROUND OF THE INVENTION

Such a device typically comprises a frame in which a shaft with blades is rotatably mounted. Drive means are typically further provided for rotatingly driving the shaft. In existing lawn aerators use is made of a shaft to which a number of blades are attached. Such embodiment has the drawback that when a blade breaks, for instance as a result of a hard object in the lawn or when a blade is worn, the whole shaft must be replaced, or must at least be removed in order to replace the blade concerned.

### SUMMARY OF THE INVENTION

The present invention has for its object to provide a device of the type stated in the preamble which is more user-friendly and easily repairable in the case of wear or damage.

The device according to the invention is distinguished for this purpose in that the shaft is provided with a plurality of mounting arms. At least one removably mounted blade body is provided on each mounting arm. The blade body is provided on the mounting arm at a location such that elements such as moss and dead grass present between the blades of grass are dislodged by the blade body during the rotation of the shaft in the frame.

By providing mounting arms on which a blade body is removably mounted the following technical advantage is gained. In the case of wear or breakage only the blade body will generally be affected and not the mounting arms. Because the blade body is mounted removably on the mounting arms, a blade body can thus be easily replaced without the whole shaft having to be replaced.

Each blade body is preferably provided with a blade part configured to dislodge moss, dead grass, twigs, leaves and the like. In addition, each blade body can be provided with a stop part configured to co-act with a protruding part on the mounting arm in order to prevent the rotation of the blade body relative to the mounting arm. Such an embodiment is particularly advantageous when the blade bodies are attached to the mounting arms using a nut/bolt connection and it is necessary to avoid the bolts coming loose when the lawn aerator is operational. The protruding part is for instance formed as a cut-out tongue which is pushed outward out of the plane of the mounting arm. Only one additional processing step is in this way necessary for the purpose of forming the protruding part.

According to an advantageous embodiment, each blade body is provided with a least two blade parts, wherein one blade part thereof functions as the stop part. When an operational blade part is worn, the blade body can in this way be mounted in rotated position such that the blade part which has functioned as stop part and is not yet worn can be used as operational blade part for dislodging debris present between the blades of grass, while the worn blade part can still be used as stop part.

Each blade body is still more preferably provided with at least three blade parts, preferably four blade parts. These blade parts are preferably arranged in a regular distribution over the periphery of the blade body. This has the advantage that, each time a blade part is worn, the blade body can be rotated such that a new blade part comes to lie at the location where the worn blade part was previously operative. The configuration with four blade parts is highly advantageous since this number makes it possible for adjacent blade parts not to impede each other, while at the same time a large number of spare blade parts is provided on the same blade body, i.e. only one blade part is operational while the other blade parts function as spare blade parts which do not disrupt operation.

Note that the blade parts preferably form an integral part of the blade body, i.e. they are formed as one part on the blade body.

The blade part preferably has a form with a substantially straight cutting edge and an inclining or arcuate rear edge, wherein the cutting edge makes an angle with the rear edge. This angle is preferably less than 90 degrees. Such a shaping ensures that the blade tip formed by the angle between the cutting edge and the rear edge remains available for a longer time, even in the case of some wear.

The mounting arms are preferably elongate plate-like elements with an opening through which the shaft passes. The mounting arms can be fixedly mounted on the shaft, but can also be mounted as clapper accordance with the type of lawn aerator that is desired. The opening can be arranged centrally in the mounting arm, wherein a blade body is then arranged at either end of the mounting arm. Adjacent mounting arms can for instance be mounted on the shaft at an angle of 60 degrees relative to each other such that the blade bodies are arranged at 60 degree intervals from each other around the shaft. A spacer can further be provided on the shaft between each pair of adjacent mounting arms in order to ensure that the blade bodies lie at a distance from each other as seen in the longitudinal direction of the shaft.

The blade body is preferably attached by a bolt and a nut. The bolt preferably passes through a central opening in the blade body for the purpose of attaching the blade body to the mounting arm.

The blade body preferably has a substantially flat side which partially supports against a flat side of the mounting arm such that a blade body is firmly fixable against the mounting arm, for instance with a nut and bolt connection.

According to a variant, the blade body is provided with a non-rotation-symmetrical opening through which a shaft part with a complementary shape passes for the purpose of attaching the blade body to the mounting arm. In this way a stop part is not required for the purpose of guaranteeing a firm non-rotatable attachment of a blade body to a mounting arm.

The invention further relates to a shaft assembly with mounting arms for use in a device according to any of the above described embodiments. The shaft assembly can have one or more of the above described features.

The invention also relates to a blade body for use in a device according to any of the above described embodiments and to a mounting arm for use in such a device.

### BRIEF DESCRIPTION OF THE DRAWING FIGURES

The present invention will be further elucidated on the basis of a number of by no means limitative exemplary embodiments, with reference to the accompanying drawings, in which:

FIG. 1 is a perspective view on embodiment of a shaft assembly for mounting in a lawn aerator;

FIG. 2 is a perspective detail view of a mounting arm with blade bodies of the embodiment of FIG. 1;

FIG. 3 is a perspective detail view of the mounting arm of FIG. 2 without the blade bodies;

FIG. 4 illustrates a first embodiment of a blade body;

FIG. 5 illustrates a second embodiment of a blade body; and

FIG. 6 illustrates a third embodiment of a blade body.

### DETAILED DESCRIPTION OF THE INVENTION

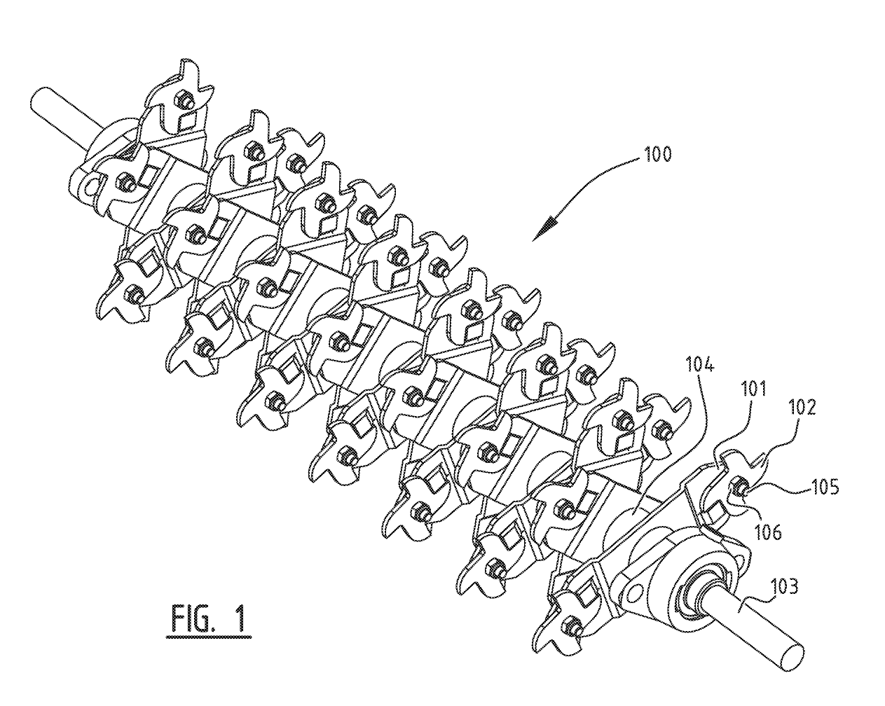

FIG. 1 illustrates a shaft assembly 100 intended for rotatable mounting in a frame of a lawn aerator or verticutter. The lawn aerator is typically further provided with a motor, for instance an electric motor or a petrol engine, for rotatingly driving shaft 103. Shaft 103 is provided with a plurality of mounting arms 101 mounted at a distance from each other on shaft 103. A spacer 104 is provided for this purpose on shaft 103 between each pair of adjacent mounting arms 101. This spacer 104 can for instance be a metal or nylon spacer which is pushed over shaft 103. Mounting arms 101 are preferably manufactured from metal.

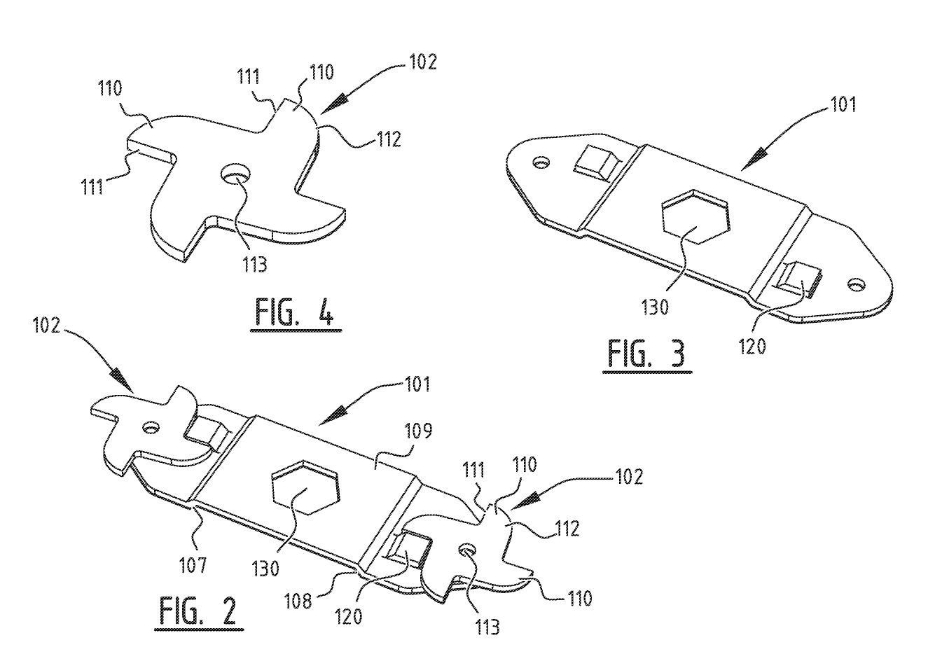

A mounting arm 101 is shown in detail in FIG. 2. Mounting arm 101 is substantially plate-like and has an elongate form. A blade body 102 is mounted on either side of the elongate mounting arm 101. Mounting arm 101 is provided with a central opening 130 through which the shaft 103 extends. According to the illustrated embodiment, opening 130 is not rotation-symmetrical such that mounting arm 101 can be mounted non-rotatably on shaft 103. As illustrated in FIG. 1, adjacent mounting arms can for instance be mounted at an angle of 60 degrees relative to each other on shaft 103 such that the blade bodies are distributed regularly over the periphery of the shaft. The plate-like mounting arm 101 can further have a relief 107, 108 so as to ensure that the plate-like blade bodies 102 do not protrude, or hardly so, relative to an upper side 109 of mounting arm 101.

Blade bodies 102 are mounted removably on mounting arms 101. The mounting of blade bodies 102 at both ends of mounting arms 101 can for instance take place using a bolt-nut assembly 105, 106, see FIG. 1, wherein bolt 105 passes through a central opening 113 of blade body 102. The blade bodies can in this way be easily removed and replaced, for instance in the case of wear. Since both the blade bodies 102 and the mounting arm 101 are flat, they can be fixed firmly against each other.

Blade body 102 is shown in detail in FIG. 4. The blade body is plate-like and formed with four blade parts 110 in regular distribution along the periphery of the blade body. Each blade part 110 has a substantially straight cutting edge 111 and an arcuate rear edge 112. Cutting edge 111 makes an angle of less than 90 degrees with the arcuate rear edge 112. Such a blade part 110 can cut into and dislodge disruptive elements present between the blades of grass during rotation of shaft 103.

Mounting arm 101 is shown in detail without blade bodies 102 in FIG. 3 and is provided with two protruding parts 120. Such a protruding part 120 can be formed by cutting out a tongue in mounting plate 101 and pushing this tongue outward in order to obtain a protruding part 120 intended for co-action with a cutting edge 111 of blade body 102. One of the blade parts 110 therefore functions here as stop part which co-acts with protruding part 120 and ensures that rotation of blade body 102 is avoided while the lawn aerator is in operation.

FIGS. 1-4 further illustrate that both the mounting arm and the blade bodies are preferably substantially flat, this such that blade body 102 can support with a flat side against mounting arm 101, The blade bodies are in this way supported in robust manner.

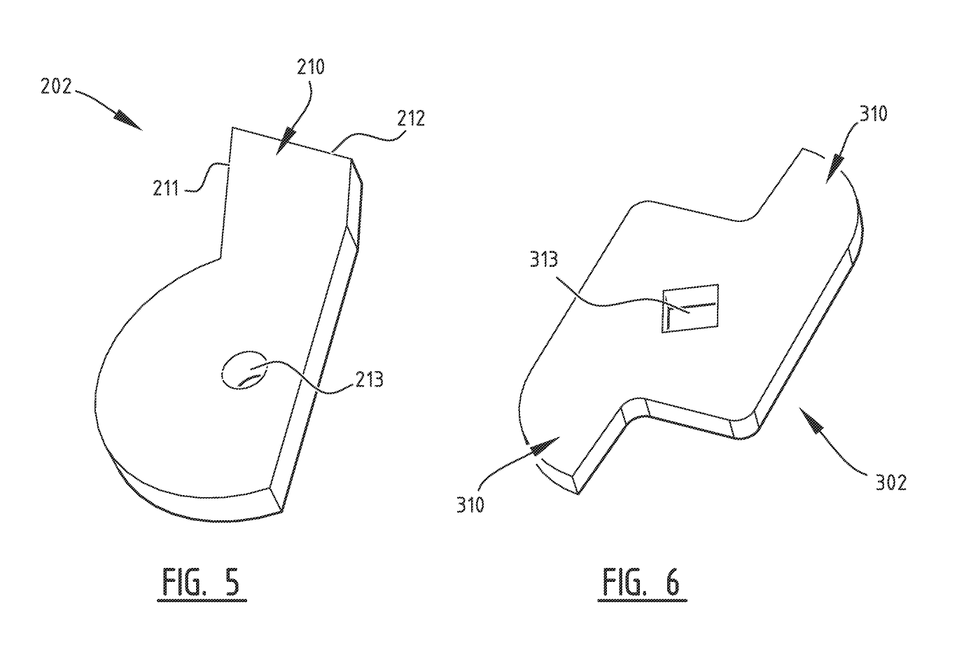

FIGS. 5 and 6 illustrate two further variants of blade bodies according to the invention. In the variant of FIG. 5 the blade body 202 is provided with one blade part 210 with a straight cutting edge 200 and an inclining rear edge 212. Blade body 202 is further provided with an opening 213 through which a bolt can be placed for the purpose of attaching blade body 202 to a mounting arm.

FIG. 6 illustrates an embodiment of a blade body 302 with two blade parts 310. Blade parts 310 are somewhat similar here to the above described blade parts 110. Here also a first blade part 310 can function as the actual blade, while the second blade part can also function as stop. As illustrated, it is also possible to provide blade body 302 with a central opening 313 with a non-rotation-symmetrical form. When a shaft part is used with a section of complementary form, the blade body can then also be mounted non-rotatably on a mounting arm without a protruding par top part being required.

The skilled person will appreciate that the invention is not limited to the above illustrated exemplary embodiments and that many variants and modifications can be envisaged within the scope of the invention, which is defined solely by the following claims.

1. Device for aerating a lawn, comprising a frame in which a shaft is rotatably mounted, characterized in that the shaft is provided with a plurality of mounting arms, wherein each mounting arm is provided with at least one removably mounted blade body, which blade body is provided on the mounting arm at a location such that disruptive elements in the lawn, such as moss and dead grass, are dislodged by the blade body during the rotation of the shaft.

2. Device as claimed in claim 1, wherein each blade body is provided with a blade part configured to dislodge the disruptive elements between the blades of grass in the lawn.

3. Device as claimed in claim 1, wherein each mounting arm is provided with a protruding part and that each blade body is provided with a stop part configured to co-act with the protruding part on the mounting arm in order to prevent the rotation of the blade body relative to the mounting arm.

4. Device as claimed in claim 3, wherein each blade body is provided with a least two blade parts, wherein one blade part thereof functions as the stop part.

5. Device as claimed in claim 3, wherein the protruding part is formed by a cut-out, outward pressed tongue which forms an integral part of the mounting arm.

6. Device as claimed in claim 1, wherein each blade body is provided with at least three blade parts, preferably four blade parts.

7. Device as claimed in claim 2, wherein each blade part has a substantially straight cutting edge and an inclining or arcuate rear edge, which cutting edge makes an angle with the rear edge which is less than or equal to 90 degrees.

8. Device as claimed in claim 2, wherein each blade part is formed on the blade body.

9. Device as claimed in claim 1, wherein each mounting arm is an elongate plate-like element with an opening through which the shaft passes.

10. Device as claimed in claim 9, wherein the opening is arranged centrally in the mounting arm, and that a blade body is arranged at either end of the mounting arm.

11. Device as claimed in claim 1, wherein each blade body is attached by a bolt and a nut.

12. Device as claimed in claim 11, wherein the blade body is provided with an opening through which the bolt passes.

13. Device as claimed in claim 1, wherein each blade body is substantially flat and supports with a part of a flat side thereof against a flat side of the mounting arm.

14. Device as claimed in claim 1, wherein a spacer is provided on the shaft between each pair of adjacent mounting arms of the plurality of mounting arms.

15. Device as claimed in claim 1, wherein each blade body is provided with a non-rotation-symmetrical opening through which a shaft part with a complementary shape passes for the purpose of attaching the blade body to the mounting arm.

16. Device as claimed in claim 1, wherein the device further comprises drive means for rotatingly driving the shaft.

17. Shaft assembly for use in a device as claimed in claim 1, which shaft assembly comprises a shaft provided with a plurality of mounting arms, wherein each mounting arm is provided with at least one removably mounted blade body, which blade body is provided on the mounting arm at a location such that disruptive elements in the lawn, such as moss and dead grass, are dislodged by the blade body during the rotation of the shaft.

18. Device for aerating a lawn, comprising a frame in which a shaft is rotatably mounted, characterized in that the shaft is provided with a plurality of mounting arms, wherein each mounting arm is provided with at least one removably mounted blade body, which blade body is provided on the mounting arm at a location such that disruptive elements in the lawn, such as moss and dead grass, are dislodged by the blade body during the rotation of the shaft; wherein each mounting arm is provided with a protruding part and that each blade body is provided with a stop part configured to co-act with the protruding part on the mounting arm in order to prevent the rotation of the blade body relative to the mounting arm; wherein each mounting arm is an elongate plate-like element with an opening through which the shaft passes.

19. Device as claimed in claim 18, wherein each blade body is provided with a least two blade parts, wherein one blade part thereof functions as the stop part.

20. Blade body for use in a device as claimed in claim 1, wherein said blade body is provided with a stop part configured to co-act with a protruding part on the mounting arm, wherein said blade body is provided with at least two blade parts wherein one blade part functions as the stop part.
